(19) United States
(12) Patent Application Publication
(10) Pub. No.: US 2013/0312585 A1
(43) Pub. Date: Nov. 28, 2013

(54) DRUM SKIN FOR VOLUME-REDUCED OR ELECTRONIC DRUMS

(71) Applicant: TIANJIN JINBAO MUSICAL INSTRUMENTS CO., LTD, Tianjin City (CN)

(72) Inventors: Liu Yunbin, Tianjin City (CN); Dai Yongcai, Tianjin City (CN)

(73) Assignee: TIANJIN JINBAO MUSICAL INSTRUMENTS CO., LTD, Tianjin City (CN)

(21) Appl. No.: 13/746,336

(22) Filed: Jan. 22, 2013

(30) Foreign Application Priority Data
May 24, 2012 (CN) 2012101648116
May 24, 2012 (CN) 2012202380389

(51) Int. Cl. G10D 13/02

(52) U.S. Cl. CPC G10D 13/027
USPC 84/414; 427/372.2

(57) ABSTRACT

The invention relates to a drumhead for volume-reduced and electronic drums, comprising an elastic mesh, fixed on a drumframe and elastic colloidal coatings integrally formed on the upper and lower surfaces of the elastic mesh. The colloidal coating covers at least a part of the surfaces of the elastic mesh. The elastic mesh uses one of polyester mesh, nylon mesh, cotton-fiber and mesh. Said elastic colloidal coating is round and located at the center of the drum, and has an area of 5%-100% of the entire drumhead surface. By injecting the colloid on the mesh according to the invention, the strength, elasticity and wear resistance of the elastic mesh body can be improved, and the lifetime of the drumhead can be extended up to five times. The invention reduces the sound of the drumstick by 20 dB.

### FIELD OF THE INVENTION

The present invention relates to the art of musical instrument, particularly to a drumhead for volume-reduced drums and/or electronic drums.

### BACKGROUND OF THE INVENTION

At present, percussion instruments are very popular musical instruments, which can directly cause resonance between the drummer and audiences. This kind of instrument depends entirely on the skill of the drummer to make sound. So, for either a professional drummer or a learner it is necessary to frequently and continuously practice to improve their playing skills, according to the saying “practice makes perfect”. Besides, for getting familiar with a real reaction of drumhead, the drummer or learner also needs to beat a real drum during practice in order to enhance the drumming skills. But, beating a real drum will generate a loud sound, which could easily bother other people. Such deafening sound becomes a significant noise to the others. For solving this problem, a special kind of drum for practice, i.e. a drum with reduced sound volume, is known. The volume-reduced drum is different from the drumhead of traditional drum in that it is not made of polyester film but rather of a mesh body. By stretching the mesh over a frame, it can then be beaten creating a sound like a normal drumhead. When compared to the traditional drum, the sound volume of the volume-reduced drum is greatly reduced. Besides, since it is a real piece of drumhead, the volume-reduced drum can also provide an experience to the drummer letting him feel a true reaction of beating the drumhead. Therefore, this kind of drum is widely used by drummers in their practices to reduce the sound volume and avoid unnecessary noise to the environment.

However, as shown in FIG. 1, the existing technique of reinforcing the drumhead usually consists of applying and laminating multiple layers of mesh. The manufacturing method consists of simultaneously stretching plural pieces of mesh over the same frame. Since there are gaps between these mesh layers, the upper mesh layer and the lower mesh layer will collide with each other when drumming. After having experienced such collision over a long time, the meshes will become easily damaged resulting in bad elasticity, wear resistance and a reduced life. Furthermore, the collision will also generate noise and thus cannot really provide the “muting” effect of the volume-reduced drumhead. Moreover, beating such combined mesh layers will generate excessively strong rebound. This makes the beating feeling different from the real drumhead and thus the drummer will not experience the reaction of real drumhead during drumming.

The electronic drum is a kind of musical instrument that acquires beating signals on the drum surface by an electronic signal collecting means, amplifies the signals and then generates a sound by means of a sound generating means. Commonly used drumheads on electronic drums include a single-layer-wire mesh drumhead and a double-layer-wire mesh drumhead, wherein the single-layer-mesh drumhead is usually made of fiber wire mesh material and the like. The drawback of this kind of drumhead is its overlarge hardness and elasticity, and a lack of adjustability in terms of elasticity. The double layer-wire mesh drumhead is formed by stacking two layers of wire mesh together. This kind of drumhead has an advantage of moderate elasticity as compared to the single-layer-mesh drumhead. However, its own vibration is too strong resulting in cross talk and sound feedback problems. In addition, the single-layer-wire mesh drumhead and the double layer-wire mesh drumhead are both not at vibration absorption.

### SUMMARY OF THE INVENTION

An object of the present invention is to provide a mesh drumhead for use in volume-reduced and electronic drums, which has a strength, elasticity and wear resistance comparable to a traditional drumhead.

For solving the above-mentioned problems found in the prior art and accomplishing the above-stated object, the present invention refers to the following techniques: the invention provides a mesh drumhead which comprises an elastic mesh to be affixed on a drum frame and elastic colloidal coatings which are integrally formed on both the upper and lower surfaces of the elastic mesh. The colloidal coatings cover the entire or only a part of the upper and lower surfaces of the elastic mesh.

The colloidal coating is the result of the application of a colloidal solution to a basic mesh material by spraying the solution onto the material from one side or from both sides or immersing the material into the solution. The resulting coating may in particular consist of elastic rubber or silicone rubber. The main component of the rubber is polyisoprene (C₅H₈)ₙ, vulcanized rubber elastomer, silicone rubber TB1207F (Three Bond 1207F), elastomer curing at room temperature or a suitable mixture thereof.

The coating material could further be injected or pressed into the mesh material using a metal mold.

The resulting elastic mesh would thus consist of a mesh body partly or entirely coated with rubber or elastomer. The fraction of the surface of the mesh body coated with rubber or elastomer could amount to 10% to 100% of the total surface area.

The elastic mesh may be any of the polyester mesh, nylon mesh, cotton fiber mesh and polyester mesh.

The colloidal coating may be made of rubber, silicone or soft PVC, PU or other elastic colloid.

The mesh may have a size of 20 to 200 eye, and a thickness of 0.2 to 1.0 mm.

The thickness of the colloidal coatings of said upper and said lower surfaces may respectively be 0.4 to 3 mm.

Said elastic colloidal coating is round and located in a central portion of the drumhead, and covers between 5%-100% of the drumhead surface area.

The areas of said colloidal coatings formed on the mesh upper and lower surfaces may be equal or different from each other.

The colloid of the colloidal coatings on the upper and lower surfaces of the mesh is injected or infused into the mesh material and fill up holes of the mesh such that the coatings on the upper surface and on the lower surface can combined together to become one body.

The advantages of the present invention include: by forming the colloidal coating on the elastic mesh, the strength, elasticity and wear resistance of the entire elastic mesh body can be greatly improved, the lifetime of the drumhead can be extended five times; the sound generated by the drumstick can be reduced by 20 dB. Therefore, the drumhead of the invention is more suitable for volume-reduced drums and electronic drums. After coating the colloid, the elasticity of the drumhead is increased and thus the drumming feeling is particularly good. In addition, the invention can prevent the hands from getting tired even after playing for a long time.

### BRIEF DESCRIPTION OF THE DRAWINGS

FIG. 1 is a perspective view of a drumhead according to the prior art.

FIG. 2 is a schematic diagram of the drumhead for volume-reduced and electronic drums according to the present invention.

FIG. 3 is a cross-sectional view of the drumhead according to the present invention.

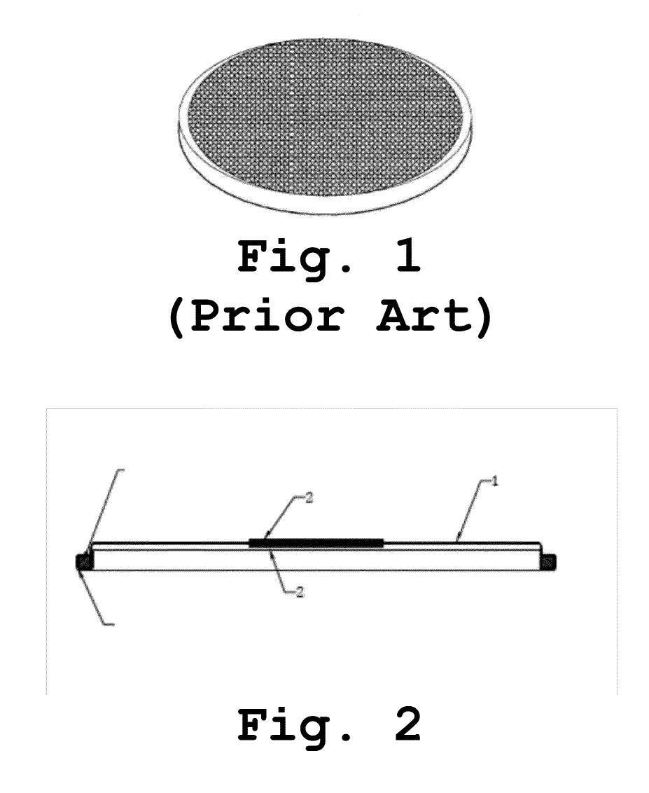

### DETAILED DESCRIPTIONS OF THE INVENTION

Hereafter, embodiment of the present invention will be described with reference the accompanying drawings. The working principle of the volume-reduced drum and the electronic drum in the present invention has similarities with that of the prior art. The present invention differs from the prior art mainly in the structure of drumhead as described below in detail.

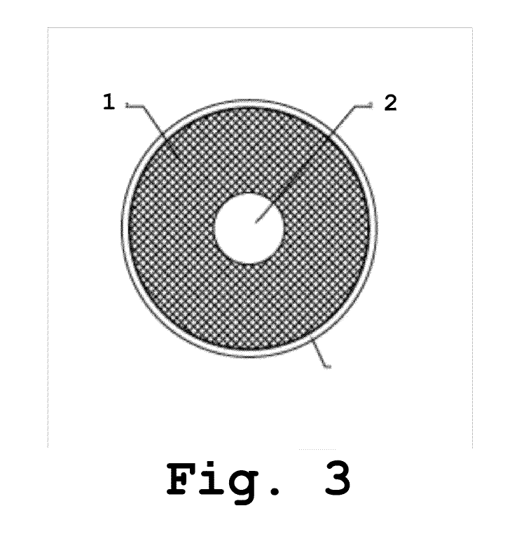

As shown in FIGS. 2 and 3, the drumhead of the present invention comprises an elastic mesh 1 which is fixed on the drum frame 3, and elastic colloidal coatings 2 which are integrally formed on the upper and lower surfaces of the elastic mesh 1. The colloidal coatings 2 cover the entire or a part of the upper and lower surfaces of the elastic mesh 1. The elastic mesh 1 can be polyester mesh, nylon mesh, cotton fiber mesh or polyester mesh. The colloidal coating is made of rubber, silicone or soft PVC, PU or other elastic soft colloid. The elastic mesh 1 has a size of about 20 to 200 eye (holes per cm2), and a thickness of about 0.2 to 1.0 mm. The thickness of the colloidal coating 2 on said upper surface and on said lower surface are preferably between 0.4 to 3 mm. The elastic colloidal coating 2 has a round shape, and is located at the center of the drumhead. It covers between 5%-100% of the entire drumhead surface area. The colloidal coatings 2 on the upper and lower surfaces of the mesh 1 could have the same size or not.

When forming the colloidal coatings 2 by injection, the colloid material can be infused into the mesh 1 and fill up the holes of the mesh 1. After injecting or infusing the colloidal suspension, the drum skin will be dried such that the colloidal particles combine to form the elastic coating. Thereby, the coating on the mesh upper surface and the coating on the mesh lower surface will combine to each other and become one body.

In practice, the thickness and area of the colloidal coating 2 can be adjusted in accordance with the actual design in order to meet different technical requirements.

The above specifically describes an embodiment of the invention. However, the present invention is not limited to the above embodiment, and can of course be variously modified without departing from the scope of the present invention.

1. A drum skin for volume-reduced or electronic drums, comprising:
an elastic mesh (1) suitable for being fixed on a drum frame (3), at least one elastic coating (2) integrally formed on at least one of: an upper surface and a lower surface of said elastic mesh (1), said at least one coating (2) covering at least: a part of said upper and lower surfaces of the elastic mesh (1).

2. The drum skin according to claim 1, wherein said at least one elastic coating (2) is a colloidal coating.

3. The drum skin according to claim 1, wherein said elastic mesh (1) is a polyester mesh, a nylon mesh, or a cotton-fiber mesh.

4. The drum skin according to claim 1, wherein said at least one elastic coating (2) is made of: rubber, silicone, soft PVC, PU or an elastic soft colloid.

5. The drum skin according to claim 1, wherein the elastic mesh (1) has a size of about 20 to 200 eyeholes per cm2. and a thickness of 0.2 to 1.0 mm.

6. The drum skin according to claim 1, wherein the elastic mesh (1) has a thickness of about 0.2 to 1.0 mm.

7. The drum skin according to claim 1, wherein the at least one elastic coating (2) of said upper and lower surfaces are about 0.4 to 3 mm in thickness.

8. The drum skin according to claim 1, wherein said at least one elastic coating (2) is round.

9. The drum skin according to claim 1, wherein said at least one elastic coating (2) is located in a central portion of a drumhead.

10. The drum skin according to claim 1, wherein said at least one elastic coating (2) covers between 5%-100% of a drum skin surface area.

11. The drum skin according to claim 1, wherein said at least one elastic coatings (2) formed on the upper and lower surfaces of the elastic mesh (1) are equal in area.

12. The drum skin according to claim 1, wherein said at least one elastic coatings (2) formed on the upper and lower surfaces of the elastic mesh (1) are unequal in area.

13. The drum skin according to claim 1, wherein the at least one elastic coatings (2) on the upper and lower surfaces of the elastic mesh (1) are formed such that holes of the elastic mesh (1) are filled by an elastic material of the coating so as to combine the at least one coatings (2) on the two surfaces by direct material bonding.

14. The drum skin according to claim 1, further comprising a drum frame (3), wherein the elastic mesh (1) is fixed on said drum frame (3).

15. A method of manufacturing a drum skin, comprising the steps of:
providing an elastic mesh (1) suitable for being fixed on a drum frame (3);
injecting or infusing a colloidal suspension or solution onto a material of the elastic mesh (1); and subsequently drying the drum skin in order to produce the elastic coating.
